(19) United States
(12) Patent Application Publication
(10) Pub. No.: US 2024/0088403 A1
(43) Pub. Date: Mar. 14, 2024

(54) MEMBRANE ELECTRODE ASSEMBLY

(71) Applicant: TOYOTA JIDOSHA KABUSHIKI KAISHA, Toyota-shi (JP)

(72) Inventors: Kimihiro TSUCHIYA, Fuji-shi (JP); Takeshi NOBUKAWA, Toyota-shi (JP)

(73) Assignee: TOYOTA JIDOSHA KABUSHIKI KAISHA, Toyota-shi (JP)

(21) Appl. No.: 18/464,616

(22) Filed: Sep. 11, 2023

(30) Foreign Application Priority Data
Sep. 13, 2022 (JP) 2022-145204

(51) Int. Cl. H01M 4/92; H01M 8/1004

(52) U.S. Cl. CPC H01M 4/921; H01M 4/926; H01M 8/1004; C25B 1/04

(57) ABSTRACT

A membrane electrode assembly includes a cathode catalyst layer, an anode catalyst layer, an electrolyte layer disposed between the cathode catalyst layer and the anode catalyst layer and an intermediate layer disposed between the anode catalyst layer and the electrolyte layer. The intermediate layer includes a carrier with an insulating property, and a recombination catalyst supported on the carrier with the insulating property.

### CROSS-REFERENCE TO RELATED APPLICATION

This application claims priority to Japanese Patent Application No. 2022-145204 filed on Sep. 13, 2022, incorporated herein by reference in its entirety.

### BACKGROUND

### 1. Technical Field

The present application relates to a membrane electrode assembly, and more particularly to a membrane electrode assembly for water electrolysis.

### 2. Description of Related Art

In recent years, hydrogen has attracted attention as a CO₂-free energy source. Examples of methods for producing hydrogen include alkaline water electrolysis, polymer electrolyte membrane (PEM) water electrolysis, and so forth. Among these, PEM water electrolysis is attracting attention due to the high efficiency thereof.

Now, during water electrolysis, a phenomenon called “hydrogen crossover” occurs, in which hydrogen generated in a cathode catalyst layer (hydrogen electrode catalyst layer) permeates an electrolyte membrane and migrates to an anode catalyst layer (oxygen electrode catalyst layer) side. As a result, hydrogen becomes mixed in with oxygen generated at the anode catalyst layer, and the hydrogen concentration in the oxygen increases. Accordingly, there is a need to suppress increase in hydrogen concentration in the oxygen on the anode catalyst layer side due to hydrogen crossover.

Japanese Unexamined Patent Application Publication No. 2019-167619 (JP 2019-167619 A) and Japanese Unexamined Patent Application Publication (Translation of PCT Application) No. 2020-514528 (JP 2020-514528 A) disclose technology for suppressing increase in hydrogen concentration in the oxygen in a membrane electrode assembly for PEM water electrolysis, by causing the hydrogen that has migrated by crossover to react with the oxygen, using a recombination catalyst. Specifically, this is carried out as follows.

JP 2019-167619 A discloses a laminated electrolyte membrane that includes a first electrolyte membrane, a second electrolyte membrane, and a nanosheet laminated catalyst layer that is interposed between the first electrolyte membrane and the second electrolyte membrane, and that includes a laminated structure in which a plurality of nanosheet-like catalysts are laminated with gaps therebetween. In JP 2019-167619 A, the nanosheet-like catalyst functions as the recombination catalyst.

JP 2020-514528 A discloses a catalyst-coated membrane for use in a water electrolysis cell, having a laminate structure including a first layer that includes a first membrane component with the first membrane component having a cathode catalyst layer disposed on a first face thereof, a second layer that includes a second membrane component with the second membrane component having an anode catalyst layer disposed on a first face thereof, and an intermediate layer that is disposed between the first layer and the second layer and that includes a third membrane component with the third membrane component having a recombination catalyst layer disposed on a first face thereof.

### SUMMARY

As described in JP 2019-167619 A and JP 2020-514528 A, disposing a recombination catalyst in a membrane electrode assembly for water electrolysis enables increase in hydrogen concentration in the oxygen to be suppressed. However, structures of the membrane electrode assemblies disclosed in JP 2019-167619 A and JP 2020-514528 A are complicated, and require repeated joining processes, resulting in many fabrication steps. Accordingly, the present inventors fabricated a prototype of a membrane electrode assembly having a simpler structure in which the electrolyte layer on the oxygen electrode side was removed. As a result, the hydrogen concentration reduction effects of the recombination catalyst were weakened.

The present disclosure provides a membrane electrode assembly, which is capable of suppressing increase in hydrogen concentration in the oxygen due to hydrogen crossover, by way of a catalyst layer having a simple configuration.

A membrane electrode assembly according to a first aspect of the present disclosure includes a cathode catalyst layer, an anode catalyst layer, an electrolyte layer disposed between the cathode catalyst layer and the anode catalyst layer, and an intermediate layer disposed between the anode catalyst layer and the electrolyte layer. The intermediate layer includes a carrier with an insulating property, and a recombination catalyst supported on the carrier with the insulating property.

In the membrane electrode assembly according to the first aspect of the present disclosure, the recombination catalyst may be platinum.

In the membrane electrode assembly according to the first aspect of the present disclosure, the recombination catalyst may be a platinum alloy including platinum and an alloying element. The alloying element may be at least one metal element selected from a group consisting of cobalt, nickel, iron, manganese, tantalum, titanium, hafnium, tungsten, zirconium, niobium, aluminum, tin, molybdenum, and silicon.

In the membrane electrode assembly according to the first aspect of the present disclosure, the carrier with the insulating property may be at least one metal oxide selected from a group consisting of tin oxide, titanium oxide, niobium oxide, molybdenum oxide, and tungsten oxide.

In the membrane electrode assembly according to the first aspect of the present disclosure, electrical conductivity of the carrier with the insulating property on which the recombination catalyst is supported may be 2.7×10⁻³ Scm⁻¹ or lower.

In the membrane electrode assembly according to the first aspect of the present disclosure, the electrical conductivity of the carrier with the insulating property on which the recombination catalyst is supported may be 2.7×10⁻⁵ Scm⁻¹ or lower.

In the membrane electrode assembly according to the first aspect of the present disclosure, the electrical conductivity of the carrier with the insulating property on which the recombination catalyst is supported may be 1.2×10⁻⁸ Scm⁻¹ or lower.

In the membrane electrode assembly according to the first aspect of the present disclosure, the intermediate layer may include an ionomer with proton conductivity.

In the membrane electrode assembly according to the first aspect of the present disclosure, the carrier with the insulating property may be particulate, and a grain size of the carrier with the insulating property may be 0.01 μm to 1 μm.

According to the membrane electrode assembly of the present disclosure, increase in hydrogen concentration in the oxygen due to hydrogen crossover can be suppressed.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic cross-sectional view of a membrane electrode assembly 100; and

FIG. 2 is a schematic cross-sectional view of a membrane electrode assembly 200.

### DETAILED DESCRIPTION OF EMBODIMENTS

Membrane Electrode Assembly

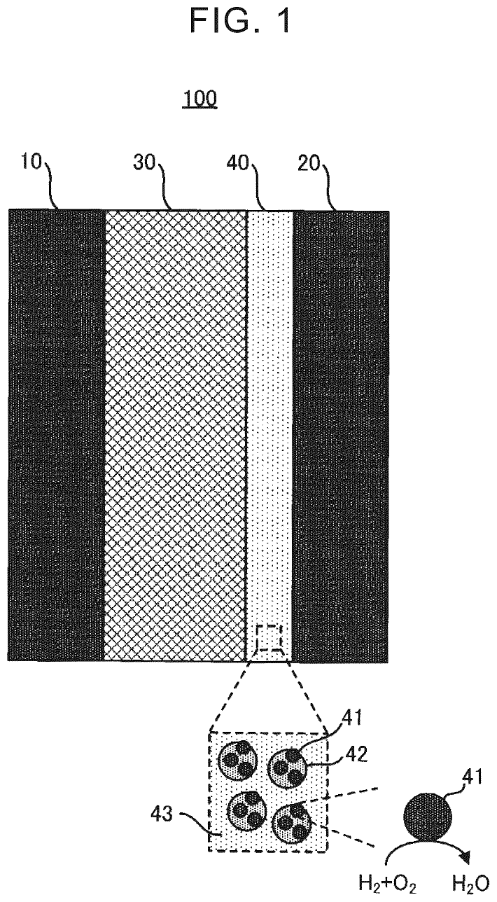

A membrane electrode assembly (MEA) according to the present disclosure will be described by way of a membrane electrode assembly 100 according to an embodiment. FIG. 1 illustrates a schematic cross-sectional view of the membrane electrode assembly 100.

As illustrated in FIG. 1, the membrane electrode assembly 100 has a cathode catalyst layer 10, an anode catalyst layer 20, an electrolyte layer 30, and an intermediate layer 40, with the electrolyte layer 30 being disposed between the cathode catalyst layer 10 and the anode catalyst layer 20, and the intermediate layer 40 being disposed between the anode catalyst layer 20 and the electrolyte layer 30.

Cathode Catalyst Layer 10

The cathode catalyst layer (hydrogen electrode catalyst layer) 10 contains a cathode catalyst that is capable of generating hydrogen by water electrolysis. Examples of cathode catalysts include metal catalysts, although not limited thereto in particular. Examples of metal catalysts include a metal catalyst containing at least one type of metal selected from platinum (Pt), ruthenium (Ru), rhodium (Rh), osmium (Os), iridium (Ir), palladium (Pd), and gold (Au) in the composition thereof. The metal catalyst may be oxides of these metals. The cathode catalyst may be made up of a single metal catalyst, or may be a mixture of a plurality of types of metal catalysts.

The cathode catalyst may be an electrically conductive carrier supporting a metal catalyst (metal supporting catalyst). Examples of the carrier include carbon carriers, although not limited thereto in particular. The supported amount of the metal catalyst on the carrier is in a range of 5% to 90% by weight for example, although not limited thereto in particular. In some embodiments, the cathode catalyst may be a platinum-supporting carbon catalyst.

The form of the cathode catalyst is usually a powder type, although not limited thereto in particular. The grain size of the powder can be set as appropriate in accordance with the purpose.

The cathode catalyst layer 10 may include an ionomer having proton conductivity. The ionomer is not limited in particular. Examples include proton-conductive polymers. Examples of proton-conductive polymers include fluoroalkyl polymers such as polytetrafluoroethylene and so forth, fluoroalkyl polymers and so forth, such as perfluoroalkyl sulfonate polymers and so forth.

The weight ratio of the metal catalyst to the ionomer in the cathode catalyst layer 10 is in a range of 20:1 to 1:2 for example, although not limited thereto in particular. The weight ratio of the metal supporting catalyst to the ionomer in the cathode catalyst layer 10 is in a range of 1:1 to 1:20 for example, although not limited thereto in particular.

In the cathode catalyst layer 10, the weight per unit area of the metal catalyst is in a range of 0.01 mg to 2.0 mg for example, although not limited thereto in particular. In the cathode catalyst layer 10, the weight per unit area of the metal supporting catalyst is in a range of 0.015 mg to 40 mg for example, although not limited thereto in particular.

The thickness of the cathode catalyst layer 10 is in a range of 0.1 μm to 20 μm for example, although not limited thereto in particular.

Anode Catalyst Layer 20

The anode catalyst layer (oxygen electrode catalyst layer) 20 contains an anode catalyst that is capable of generating oxygen by water electrolysis. Examples of anode catalysts include metal catalysts, although not limited thereto in particular. Examples of metal catalysts include a metal catalyst containing at least one type of metal selected from Pt, Ru, Rh, Os, Ir, Pd, and Au in the composition thereof. The metal catalyst may be oxides of these metals. The anode catalyst may be made up of a single metal catalyst, or may be a mixture of a plurality of types of metal catalysts. In some embodiments, the anode catalyst may be iridium oxide.

The anode catalyst may be an electrically conductive carrier supporting a metal catalyst (metal supporting catalyst). Examples of types of the carrier include titanium oxide carriers, although not limited thereto in particular. The supported amount of the metal catalyst on the carrier is in a range of 5% to 90% by weight for example, although not limited thereto in particular.

The form of the anode catalyst is usually powder type, although not limited thereto in particular. The grain size of the powder can be set as appropriate in accordance with the purpose.

The anode catalyst layer 20 may include an ionomer having proton conductivity. The ionomer is not limited in particular. For example, the ionomer may be selected as appropriate from the ionomers used for the cathode catalyst layer 10.

The weight ratio of the metal catalyst to the ionomer in the anode catalyst layer 20 is in a range of 1:5 to 100:1 for example, although not limited thereto in particular. The weight ratio of the metal supporting catalyst to the ionomer in the anode catalyst layer 20 is in a range of 1:5 to 100:1 for example, although not limited thereto in particular.

In the anode catalyst layer 20, the weight per unit area of the metal catalyst is in a range of 0.1 mg to 5 mg for example, although not limited thereto in particular. In the anode catalyst layer 20, the weight per unit area of the metal supporting catalyst is in a range of 0.1 mg to 5 mg for example, although not limited thereto in particular.

The thickness of the anode catalyst layer 20 is in a range of 0.1 m to 20 m for example, although not limited thereto in particular.

Electrolyte Layer 30

The electrolyte layer 30 is not limited in particular, as long as it is made up of a polymer electrolyte having a sulfonic acid group. For example, the electrolyte layer 30 may be made up of a dry resin with an ion exchange capacity of 0.5 meq/g to 3.0 meq/g, may be made up of a dry resin with an ion exchange capacity of 0.7 meq/g to 2.5 meq/g, or may be made up of a dry resin with an ion exchange capacity of 2.5 meq/g. The reason thereof is that a dry resin with an ion exchange capacity of less than 0.5 meq/g does not have sufficient ionic conductivity, and a dry resin with an ion exchange capacity of more than 3.0 meq/g becomes a gel, and a membrane cannot be formed.

Further, from the viewpoint of durability, the polymer electrolyte may be a fluorine-containing polymer or a perfluorocarbon polymer (which may contain an etheric oxygen atom). Alternatively, the polymer electrolyte may be a perfluorocarbon polymer containing a sulfonic acid group. Examples of the perfluorocarbon polymer include a perfluorocarbon polymer having a side chain containing a sulfonic acid group, expressed as —(OCF₂CFX)m-Op-(CF₂)n-SO₃H (in which m represents an integer of 0 to 3, n represents an integer of 1 to 12, p represents 0 or 1, and X represents a fluorine atom or a trifluoromethyl group), although not limited thereto in particular.

The thickness of the electrolyte layer 30 is in a range of 1 m to 400 m for example, although not limited thereto in particular. When the thickness of the electrolyte layer 30 is smaller than 1 m, the influence of hydrogen crossover increases, and the hydrogen concentration in the oxygen on the anode catalyst layer side tends to increase. When the thickness of the electrolyte layer 30 exceeds 400 m, proton conductivity tends to decrease.

Intermediate Layer 40

The intermediate layer 40 is disposed between the anode catalyst layer 20 and the electrolyte layer 30. More specifically, the intermediate layer 40 is disposed in contact with the anode catalyst layer 20 and the electrolyte layer 30. The intermediate layer 40 contains a recombination catalyst 41 supported on a carrier 42 that has an insulating property.

The recombination catalyst 41 is not limited in particular, as long as the reaction of generating water from hydrogen and oxygen (recombination reaction) can be catalyzed. For example, the recombination catalyst 41 is platinum or a platinum alloy. In the platinum alloy, the alloying element may be at least one metal element selected from a group consisting of cobalt (Co), nickel (Ni), iron (Fe), manganese (Mn), tantalum (Ta), titanium (Ti), hafnium (Hf), tungsten (W), zirconium (Zr), niobium (Nb), aluminum (Al), tin (Sn), molybdenum (Mo), and silicon (Si). The recombination reaction activity is high when the alloying element of the platinum alloy is selected from the metal elements listed above.

The carrier 42 is not limited in particular as long as it has an insulating property, examples of which include a metal oxide carrier with an insulating property. The degree of insulation of the carrier 42 is such that the electrical conductivity is 10⁻² Scm⁻¹ or lower, the electrical conductivity is preferably 10⁻³ Scm⁻¹ or lower, more preferably 10⁻⁵ Scm⁻¹ or lower, and even more preferably 10⁻⁷ Scm⁻¹ or lower. The lower the electrical conductivity of the carrier 42 is, the higher the effects of reducing the hydrogen concentration are.

A method for measuring the electrical conductivity of the carrier 42 (the carrier 42 on which the recombination catalyst 41 is supported) is as follows. First, the carrier 42 is pressurized at 2 MPa to produce a green compact. Subsequently, a direct current electric current of 10 mA is applied to the green compact, and electric resistance R is obtained from the voltage at this time using Ohm's law. The electrical conductivity is then calculated from the following expression.

electrical conductivity (Scm⁻¹)=1/R(Ω)×thickness (cm) of green compact/area (cm²) of green compact

The metal oxide carrier may be a metal oxide that is stable under a high electrical potential (1.2 V or higher). Specifically, the carrier may be at least one metal oxide selected from a group consisting of tin oxide, titanium oxide, niobium oxide, molybdenum oxide, and tungsten oxide. For example, iron oxide is dissolved under high electrical potential. The supported amount of the recombination catalyst 41 on the carrier 42 is in a range of 5% to 90% by weight for example, although not limited thereto in particular.

The form of the carrier 42 is usually powder type, although not limited thereto in particular. That is to say, the carrier 42 is particulate. The grain size of the powder (particles) can be set as appropriate in accordance with the purpose. The grain size is 0.01 μm to 1 μm, for example.

The intermediate layer 40 may include an ionomer 43 that has proton conductivity. The ionomer 43 is not limited in particular. For example, the ionomer may be selected as appropriate from the ionomers used for the cathode catalyst layer 10.

The weight ratio of the recombination catalyst 41 to the ionomer in the intermediate layer 40 is in a range of 1:5 to 100:1 for example, although not limited thereto in particular. The weight ratio of the carrier 42 to the ionomer in the intermediate layer 40 is in a range of 1:5 to 100:1 for example, although not limited thereto in particular.

In the intermediate layer 40, the weight per unit area of the recombination catalyst 41 is in a range of 0.01 mg to 1 mg for example, although not limited thereto in particular. In the anode catalyst layer 20, the weight per unit area of the carrier 42 is in a range of 0.01 mg to 1 mg for example, although not limited thereto in particular.

Manufacturing Method of Membrane Electrode Assembly 100

The membrane electrode assembly 100 is obtained by laminating each layer on the electrolyte layer 30 as appropriate. The method for laminating each layer on the electrolyte layer 30 is not limited in particular, and a known method can be implemented. Examples include spray coating, inkjet coating, die coating, spin coating, and so forth. The electrolyte layer can be fabricate by a known method. Alternatively, the electrolyte layer may be a commercially available item.

An example of the manufacturing method of the membrane electrode assembly 100 will be described below. First, catalyst layer inks are produced by dispersing components making up each layer in respective dispersion media. There are known methods for producing catalyst layer inks. Subsequently, each layer is laminated on the electrolyte layer. The coating method described above can be used as the laminating method. The electrolyte layer on which the catalyst layers are laminated is then heated, thereby joining the electrolyte layer and the catalyst layers to each other. Thus, the membrane electrode assembly 100 can be manufactured.

Effects

One of the characteristics of the membrane electrode assembly 100 is that the recombination catalyst 41 is supported on a carrier that has the insulating property. The effects thereof will be described.

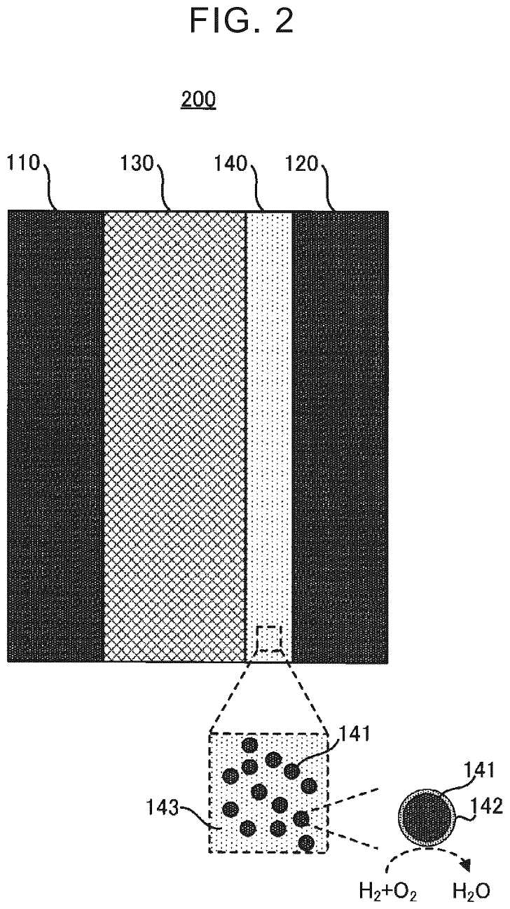

FIG. 2 illustrates a schematic cross-sectional view of a membrane electrode assembly 200 using a recombination catalyst 141 which is not supported on a carrier. As illustrated in FIG. 2, the membrane electrode assembly 200 has a cathode catalyst layer 110, an anode catalyst layer 120, an electrolyte layer 130, and an intermediate layer 140, with the electrolyte layer 130 being disposed between the cathode catalyst layer 110 and the anode catalyst layer 120. The intermediate layer 140 also includes the recombination catalyst 141 and an ionomer 143.

Providing the intermediate layer 140 in the membrane electrode assembly 200 enables a recombination reaction to occur between hydrogen that permeates and migrates through the electrolyte layer from the cathode catalyst layer 110 side, and oxygen generated at the anode catalyst layer 120. Thus, increase in hydrogen concentration in the oxygen on the anode catalyst layer 120 side can be suppressed.

On the other hand, the intermediate layer 140 is adjacent to the anode catalyst layer 120 with high electrical potential. Accordingly, the intermediate layer 140 may exhibit electrical conduction with the anode catalyst layer of which the electrical potential is high, and the surface of the recombination catalyst 141 may become oxidized. FIG. 2 illustrates a state in which the surface of the recombination catalyst 141 is oxidized (a state in which an oxide film 142 is formed on the surface of the recombination catalyst 141). When the surface of the recombination catalyst 141 is thus oxidized, the recombination reaction is inhibited by the oxide film 142, and the recombination reaction efficiency becomes lower. Consequently, increase in the hydrogen concentration in oxygen on the anode catalyst layer 120 side due to hydrogen crossover from the cathode catalyst layer 110 side cannot be sufficiently suppressed.

On the other hand, the membrane electrode assembly 100 uses an arrangement in which the recombination catalyst 41 is supported on the carrier 42 that has the insulating property. Accordingly, surface oxidation due to electrical conduction with the anode catalyst layer of which the electrical potential is high can be suppressed. Thus, according to the membrane electrode assembly 100, the recombination catalyst 41 can maintain a state in which the efficiency of the recombination reaction is high. Consequently, increase in the hydrogen concentration in the oxygen on the anode catalyst layer 20 side due to the hydrogen from the cathode catalyst layer 10 side can be sufficiently suppressed by the membrane electrode assembly 100.

Supplement

Although the intermediate layer 40 including the carrier 42 supporting the recombination catalyst 41 is provided in the membrane electrode assembly 100, an arrangement may be made in which the membrane electrode assembly according to the present disclosure does not include the intermediate layer. For example, the present disclosure may be carried out as a form in which the carrier supporting the recombination catalyst is contained (dispersed) in at least one layer of the cathode catalyst layer, the anode catalyst layer, and the electrolyte layer. Such a form also enables the recombination reaction to occur, thereby reducing the amount of hydrogen migrating to the anode catalyst layer side, and suppressing increase in hydrogen concentration in the oxygen on the anode catalyst layer side.

For example, when the cathode catalyst layer contains a carrier supporting a recombination catalyst, the recombination reaction occurs between the oxygen that has permeated from the anode catalyst layer side and the hydrogen. Thus, the amount of crossover of hydrogen can be reduced, and accordingly increase in hydrogen concentration in the oxygen on the anode catalyst layer side can be suppressed.

In the membrane electrode assembly 100, the intermediate layer is disposed between the anode catalyst layer 20 and the electrolyte layer 30, but the position at which the intermediate layer is disposed is not limited to this. In the present disclosure, the intermediate layer may be disposed between the cathode catalyst layer and the anode catalyst layer. For example, the intermediate layer may be disposed between the cathode catalyst layer and the electrolyte layer, or may be disposed within the electrolyte layer. When the electrolyte layer is made up of two layers (a first electrolyte layer and a second electrolyte layer) for example, a form in which the intermediate layer is disposed within the electrolyte layer is a form in which the intermediate layer is disposed between these two layers.

Even when the intermediate layer is disposed between the cathode catalyst layer and the anode catalyst layer, the amount of crossover of hydrogen can be reduced, and accordingly increase in hydrogen concentration in the oxygen on the anode catalyst layer side can be suppressed.

Although one intermediate layer is provided in the membrane electrode assembly 100, the number of intermediate layers in the present disclosure is not limited to this. Two or more intermediate layers may be provided. For example, intermediate layers may be disposed between the anode catalyst layer and the electrolyte layer, and between the cathode catalyst layer and the electrolyte layer. Also, intermediate layers may be disposed between the anode catalyst layer and the electrolyte layer, and within the electrolyte layer.

Thus, according to the membrane electrode assembly of the present disclosure, increase in the hydrogen concentration in the oxygen on the anode catalyst layer side due to the hydrogen crossover from the cathode catalyst layer side can be suppressed.

Water Electrolysis Cell

The present disclosure also provides a water electrolysis cell in which separators are laminated on both faces of the membrane electrode assembly. Alternatively, the present disclosure provides a water electrolysis cell in which gas diffusion layers are laminated on both faces of the membrane electrode assembly, and separators are further laminated on both faces of the laminate. The separators and the gas diffusion layers may be adopted from among known materials.

The present disclosure will be further described below by way of examples.

Fabrication of Membrane Electrode Assembly

### Example 1

A membrane electrode assembly according to Example 1 has the intermediate layer provided between the anode catalyst layer and the electrolyte layer. Fabrication procedures will be described below.

### 1. Preparation of Recombination Catalyst Ink for Intermediate Layer

First, 10 g of a platinum-supporting tin oxide catalyst (platinum-supporting amount of 20%), 1.5 g of an ionomer having proton conductivity (20% Nafion (registered trademark) dispersion solution DE2020 (manufactured by Fujifilm Wako Chemical Corporation)), 37 g of deionized water, and 56 g of ethanol were weighed, mixed in a beaker, and then dispersed by an ultrasonic homogenizer to prepare a recombination catalyst ink. At this time, the recombination catalyst ink was prepared such that the weight ratio of platinum to ionomer was at a ratio of 1:0.15.

### 2. Coating Electrolyte Layer with Recombination Catalyst Ink for Intermediate Layer

The recombination catalyst ink prepared in 1. was coated on one side of the electrolyte layer (NR212 manufactured by W. L. Gore & Associates G. K.) by a spray coater, and dried under conditions of 80° C. for five minutes. Coating was performed at this time such that the weight of platinum per unit area was 0.1 mg. Thus, the intermediate layer was laminated on the electrolyte layer.

### 3. Preparation of Anode (Oxygen Electrode) Catalyst Ink

First, 5.2 g of an iridium oxide catalyst (ElystIr750520, manufactured by Umicore), 6.8 g of an ionomer having proton conductivity (20% Nafion (registered trademark) dispersion solution DE2020 (manufactured by Fujifilm Wako Chemical Corporation)), 3.6 g of deionized water, and 6.4 g of 1-propanol were weighed, mixed in a beaker, and then dispersed by an ultrasonic homogenizer to prepare an anode (oxygen electrode) catalyst ink. At this time, the anode catalyst ink was prepared such that the weight ratio of the iridium oxide catalyst and the ionomer was at a ratio of 1:0.3.

### 4. Coating Electrolyte Layer with Anode (Oxygen Electrode) Catalyst Ink

The anode (oxygen electrode) catalyst ink prepared in 3. was coated on the intermediate layer formed on the electrolyte layer by a spray coater, and dried under conditions of 80° C. for five minutes. Coating was performed at this time such that the weight of iridium per unit area was 2.0 mg. Thus, an anode (oxygen electrode) catalyst layer was laminated on the intermediate layer.

### 5. Preparation of Cathode (Hydrogen Electrode) Catalyst Ink

First, 5 g of platinum-supporting carbon catalyst (platinum-supporting amount of 20%, manufactured by Cataler Corporation), 6.0 g of an ionomer having proton conductivity (20% Nafion (registered trademark) dispersion solution DE2020 (manufactured by Fujifilm Wako Chemical Corporation)), 67.8 g of deionized water, and 34.3 g of ethanol were weighed, mixed in a beaker, and then dispersed with an ultrasonic homogenizer to prepare a cathode (hydrogen electrode) catalyst ink. At this time, the cathode catalyst ink was prepared such that the weight ratio of carbon carrier to ionomer was at a ratio of 1:1.2.

### 6. Coating Electrolyte Layer with Cathode (Hydrogen Electrode) Catalyst Ink

The cathode (hydrogen electrode) catalyst ink prepared in 5. was coated on the surface of the electrolyte layer on the side opposite to the surface of the electrolyte layer on which the intermediate layer and the anode (oxygen electrode) catalyst layer were formed, by a spray coater, and dried under conditions of 80° C. for five minutes. Coating was performed at this time such that the weight of platinum per unit area was 0.2 mg. Thus, a cathode (hydrogen electrode) catalyst layer was laminated on the electrolyte layer.

### 7. Joining

The electrolyte layer coated with each of the catalyst layers was hot-pressed for four minutes under conditions of a temperature of 130° C. and a pressure of 130 kPa, thereby joining the electrolyte layer and the catalyst layers. Thus, a membrane electrode assembly according to Example 1 was fabricated.

### Examples 2 to 4

Membrane electrode assemblies according to Examples 2 to 4 were fabricated in the same manner as in Example 1, except that the platinum-supporting tin oxide catalyst used in the intermediate layer of Example 1 was replaced by a platinum-supporting tin oxide catalyst having the electrical conductivity shown in Table 1. Note that the electrical conductivity as used here is the electrical conductivity of the tin oxide on which the platinum is supported. That is to say, the electrical conductivity shown in Table 1 indicates the electrical conductivity of the carrier on which the recombination catalyst is supported.

### Comparative Example 1

A membrane electrode assembly according to Comparative Example 1 is an arrangement in which the intermediate layer is omitted from the membrane electrode assembly according to Example 1. Fabrication procedures will be described below.

### 1. Coating Electrolyte Layer with Anode (Oxygen Electrode) Catalyst Ink

The anode (oxygen electrode) catalyst ink prepared in 3. in Example 1 was coated on one side of the electrolyte layer (NR212 manufactured by W. L. Gore & Associates G. K.) by a spray coater, and dried under conditions of 80° C. for five minutes. Coating was performed at this time such that the weight of iridium per unit area was 2.0 mg. Thus, an anode (oxygen electrode) catalyst layer was laminated on the electrolyte layer.

### 2. Coating Electrolyte Layer with Cathode (Hydrogen Electrode) Catalyst Ink

The cathode (hydrogen electrode) catalyst ink prepared in 5. in Example 1 was coated on the surface of the electrolyte layer on the side opposite to the surface of the electrolyte layer on which the anode (oxygen electrode) catalyst layer was formed, by a spray coater, and dried under conditions of 80° C. for five minutes. Coating was performed at this time such that the weight of platinum per unit area was 0.2 mg. Thus, a cathode (hydrogen electrode) catalyst layer was laminated on the electrolyte layer.

### 3. Joining

The electrolyte layer coated with each of the catalyst layers was hot-pressed for four minutes under conditions of a temperature of 130° C. and a pressure of 130 kPa, thereby joining the electrolyte layer and the catalyst layers. Thus, a membrane electrode assembly according to Comparative Example 1 was fabricated.

### Comparative Example 2

A membrane electrode assembly according to Comparative Example 2 is an arrangement in which the platinum-supporting tin oxide catalyst in the intermediate layer of the membrane electrode assembly according to Example 1 is replaced by a non-supported platinum catalyst (using platinum itself). Fabrication procedures will be described below.

### 1. Preparation of Recombination Catalyst Ink for Intermediate Layer

First, 10 g of a non-supported platinum catalyst, 7.6 g of an ionomer having proton conductivity (20% Nafion (registered trademark) dispersion solution DE2020 (manufactured by Fujifilm Wako Chemical Corporation)), 39 g of deionized water, and 59.5 g of ethanol were weighed, mixed in a beaker, and then dispersed by an ultrasonic homogenizer to prepare a recombination catalyst ink. At this time, the recombination catalyst ink was prepared such that the weight ratio of platinum to ionomer was at a ratio of 1:0.15.

### 2. Coating Electrolyte Layer with Recombination Catalyst Ink for Intermediate Layer

The recombination catalyst ink prepared in 1. was coated on one side of the electrolyte layer (NR212 manufactured by W. L. Gore & Associates G. K.) by a spray coater, and dried under conditions of 80° C. for five minutes. Coating was performed at this time such that the weight of platinum per unit area was 0.1 mg. Thus, the intermediate layer was laminated on the electrolyte layer.

### 3. Coating Electrolyte Layer with Anode (Oxygen Electrode) Catalyst Ink

The anode (oxygen electrode) catalyst ink prepared in 3. in Example 1 was coated on the intermediate layer formed on the electrolyte layer by a spray coater, and dried under conditions of 80° C. for five minutes. Coating was performed at this time such that the weight of iridium per unit area was 2.0 mg. Thus, an anode (oxygen electrode) catalyst layer was laminated on the intermediate layer.

### 4. Coating Electrolyte Layer with Cathode (Hydrogen Electrode) Catalyst Ink

The cathode (hydrogen electrode) catalyst ink prepared in 5. in Example 1 was coated on the surface of the electrolyte layer on the side opposite to the surface of the electrolyte layer on which the intermediate layer and the anode (oxygen electrode) catalyst layer were formed, by a spray coater, and dried under conditions of 80° C. for five minutes. Coating was performed at this time such that the weight of platinum per unit area was 0.2 mg. Thus, a cathode (hydrogen electrode) catalyst layer was laminated on the electrolyte layer.

### 5. Joining

The electrolyte layer coated with each of the catalyst layers was hot-pressed for four minutes under conditions of a temperature of 130° C. and a pressure of 130 kPa, thereby joining the electrolyte layer and the catalyst layers. Thus, a membrane electrode assembly according to Comparative Example 2 was fabricated.

### Comparative Example 3

A membrane electrode assembly according to Comparative Example 3 was fabricated in the same manner as in Example 1, except that the platinum-supporting tin oxide catalyst used in the intermediate layer of Example 1 was replaced by a platinum-supporting carbon catalyst.

Evaluation

A diffusion layer made of carbon fiber was disposed on the cathode (hydrogen electrode) catalyst layer side of the membrane electrode assembly, a diffusion layer made of titanium fibers, on which surfaces platinum was vapor-deposited, was disposed on the anode (oxygen electrode) catalyst layer side, and the diffusion layer made of carbon fiber and the diffusion layer made of titanium fibers, on which surfaces platinum was vapor-deposited are assembled in a single cell (in which both anode and cathode are straight channels) with an electrode area of 1 cm². Next, water electrolysis was performed under the conditions of cell temperature of 80° C. and pressure of atmospheric pressure, by applying an electric current of a current density of 1 A/cm² using an electronic load apparatus, while circulating water of an amount several times that required for water electrolysis to both of the oxygen electrode (anode) and the hydrogen electrode (cathode). The gas and the water on the oxygen electrode (anode) side were then separated by a gas-liquid separator, and following capturing the gas component (oxygen) for 30 minutes, the hydrogen concentration in the gas component was measured using gas chromatography/mass spectrometry (GC/MS). The results are shown in Table 1.

Here, the reduction rate shown in Table 1 represents, with the hydrogen concentration of Comparative Example 1 as a reference, the reduction rate in hydrogen concentration of the other test examples. The effects in comparison with Comparative Example 2 that are shown in Table 1 represent, with the reduction rate of Comparative Example 2 as a reference, the percentages of the reduction rates of the other test examples. Effects in comparison with Comparative Example 2 that were 120% or higher were evaluated as “A”, effects in comparison therewith that were 110% or higher and lower than 120% were evaluated as “B”, and effects in comparison therewith that were 100% or higher and lower than 110% were evaluated as “C”.

TABLE 1

| | Catalyst for | Electrical | | | | |
|---|---|---|---|---|---|---|
| | intermediate | conductivity | | | Effects in | |
| | layer | of catalyst | | | comparison | |
| | (recombination | for | Hydrogen | | with | |
| | catalyst/ | intermediate | concentration | Reduction | Comparative | |
| | carrier) | layer (Scm⁻¹) | (%) | rate (%) | Example 2 | Results* |
| Example 1 | Pt/oxide | 1.2 × 10⁻⁸ | 0.2 | 78.7% | 148% | A |
| Example 2 | Pt/oxide | 3.7 × 10⁻⁶ | 0.22 | 76.6% | 144% | A |
| Example 3 | Pt/oxide | 2.7 × 10⁻⁵ | 0.26 | 72.3% | 136% | A |
| Example 4 | Pt/oxide | 2.7 × 10⁻³ | 0.35 | 62.8% | 118% | B |
| Comparative | — | — | 0.94 | 0.0% | 0% | — |
| Example 1 | | | | | | |
| Comparative | Pt | 5.1 × 10¹ | 0.44 | 53.2% | 100% | — |
| Example 2 | | | | | | |
| Comparative | Pt/C | 1.4 × 10¹ | 0.43 | 54.3% | 102% | C |
| Example 3 | | | | | | |

*C represents 100% to 110%, B represents 110% to 120%, and A represents 120% or higher Results

In Examples 1 to 4, the hydrogen concentration in the gas component was significantly lower than the hydrogen concentration in the gas component in Comparative Examples 1 to 3. On the other hand, the hydrogen concentration in the gas component was highest in Comparative Example 1 that had no intermediate layer (recombination catalyst). Also, in these results, the hydrogen concentration in the gas component in Comparative Example 2 using non-supported platinum in the intermediate layer was lower than that in Comparative Example 1, but higher than the hydrogen concentration in the gas component in Example 1. Further, Comparative Example 3, in which a platinum-supporting carbon catalyst was used in the intermediate layer, had almost the same results as in Comparative Example 2.

From the results of Comparative Examples 1 and 2, it can be seen that the recombination reaction by the intermediate layer (platinum) has effects of suppressing increase in hydrogen concentration in the gas component.

Further, from the results of Examples 1 to 4 and Comparative Examples 2 and 3, it can be seen that supporting platinum (recombination catalyst) on the tin oxide carrier improves the effects of suppressing increase in hydrogen concentration. This is thought to be due to electrical conduction to the supported platinum being suppressed even though the anode catalyst layer that is under high electrical potential and the intermediate layer are in contact with each other, since tin oxide is an insulator, and accordingly, formation of an oxide film on the surface of the platinum was suppressed. Another conceivable reason is that the above-described effects of suppressing formation of an oxide film are maintained, due to tin oxide being stable under high electrical potential. Accordingly, in Examples 1 to 4, it is thought that the hydrogen concentration in the gas component was significantly low due to the efficiency of the recombination reaction being maintained at a high level as a result of the effects of suppressing formation of an oxide film on the platinum being maintained. On the other hand, Comparative Example 2 used non-supported platinum, and Comparative Example 3 used a platinum-supporting carbon catalyst that is electrically conductive, and thus it is thought that the hydrogen concentration in the gas component was higher as compared to Examples 1 to 4 due to an oxide film being formed on the platinum, which reduces the efficiency of the recombination reaction.

Furthermore, when comparing Examples 1 to 4, it was confirmed that the lower the electrical conductivity of the catalyst (carrier) was, i.e., the lower the electrical conductivity of the carrier on which the recombination catalyst was supported, the lower the hydrogen concentration was. This is conceivably because the lower the electrical conductivity of the catalyst is, the more the oxidation of platinum is suppressed.

What is claimed is:

1. A membrane electrode assembly comprising:
a cathode catalyst layer;
an anode catalyst layer;
an electrolyte layer disposed between the cathode catalyst layer and the anode catalyst layer; and
an intermediate layer disposed between the anode catalyst layer and the electrolyte layer, the intermediate layer including a carrier with an insulating property, and a recombination catalyst supported on the carrier with the insulating property.

2. The membrane electrode assembly according to claim 1, wherein the recombination catalyst is platinum.

3. The membrane electrode assembly according to claim 1, wherein:
the recombination catalyst is a platinum alloy including platinum and an alloying element; and
the alloying element is at least one metal element selected from a group consisting of cobalt, nickel, iron, manganese, tantalum, titanium, hafnium, tungsten, zirconium, niobium, aluminum, tin, molybdenum, and silicon.

4. The membrane electrode assembly according to claim 1, wherein the carrier with the insulating property is at least one metal oxide selected from a group consisting of tin oxide, titanium oxide, niobium oxide, molybdenum oxide, and tungsten oxide.

5. The membrane electrode assembly according to claim 1, wherein electrical conductivity of the carrier with the insulating property on which the recombination catalyst is supported is 2.7×10⁻³ Scm⁻¹ or lower.

6. The membrane electrode assembly according to claim 5, wherein the electrical conductivity of the carrier with the insulating property on which the recombination catalyst is supported is 2.7×10⁻⁵ Scm⁻¹ or lower.

7. The membrane electrode assembly according to claim 5, wherein the electrical conductivity of the carrier with the insulating property on which the recombination catalyst is supported is 1.2×10⁻⁸ Scm⁻¹ or lower.

8. The membrane electrode assembly according to claim 1, wherein the intermediate layer includes an ionomer with proton conductivity.

9. The membrane electrode assembly according to claim 1, wherein:
the carrier with the insulating property is particulate; and
a grain size of the carrier with the insulating property is 0.01 μm to 1 μm.
